(19) United States
(12) Patent Application Publication
(10) Pub. No.: US 2006/0290202 A1
(43) Pub. Date: Dec. 28, 2006

(54) Vehicle braking control assistance system and method

(75) Inventors: Yumi Shibata, Okazaki-shi (JP); Yukio Yamamoto, Okazaki-shi (JP); Katsuya Maruyama, Okazaki-shi (JP)

Correspondence Address: BACON & THOMAS, PLLC, 625 SLATERS LANE, FOURTH FLOOR, ALEXANDRIA, VA, 22314, US

(73) Assignee: AISIN AW CO., LTD., Anjo-shi (JP)

(21) Appl. No.: 11/444,515

(22) Filed: Jun. 1, 2006

(30) Foreign Application Priority Data
Jun. 28, 2005 (JP) 2005-188204

(51) Int. Cl. B60T 8/66

(52) U.S. Cl. 303/165

(57) ABSTRACT

A vehicle braking control assistance device includes: a speed detecting unit for detecting current vehicle speed; a brake force detecting unit for detecting the current braking force; a deceleration target point determining unit for determining a target point for deceleration control; a target vehicle speed determining unit for determining a target vehicle speed at the deceleration target point; an ideal brake force determining unit for determining an ideal brake force to be applied in continued movement to the deceleration target point with the target vehicle speed realized at the deceleration target point, based on the current vehicle speed, the deceleration target point and the target vehicle speed; a notification information generating unit for generating notification information indicating the relationship between the ideal brake force and the current brake force; and a notification unit for bringing the generated notification information to the attention of the driver.

INCORPORATION BY REFERENCE

The disclosure of Japanese Patent Application No. 2005-188204 filed on Jun. 28, 2005, including the specification, drawings and abstract thereof, is incorporated herein by reference in its entirety.

### BACKGROUND OF THE INVENTION

1. Field of the Invention

The present invention relates to a vehicle braking control assistance system and to a vehicle braking control assistance method which assist the driver in vehicle control during braking by communicating to the driver information indicating the relationship between an ideal brake force and current brake pedal force and/or the relationship between ideal vehicle speed and current vehicle speed.

2. Description of the Related Art

One technique for assisting in vehicle control during braking provides a display of the deceleration. For example, Japanese Unexamined Patent Application Publication No. 2004-101280 (pp 3-7, Fig. 10) discloses a technique utilizing a following car navigation device which detects the deceleration, i.e. change in speed, each time the brakes of the vehicle are operated, up to the point of where the vehicle stops, and determines a pattern of the speed change which is stored as braking information. Upon application of the vehicle brakes, the deceleration at the deceleration starting point is detected and a determination is made regarding whether the deceleration is normal deceleration or full braking, by comparing with braking property patterns, and the results of the determination are displayed. Accordingly, whether or not full braking has been applied is determined by comparing the detected speed or deceleration with the stored information for normal braking, thereby preventing the screen display from becoming an annoyance to the driver.

However, full braking seldom occurs in actual driving and, also, the driver can spare little time to view a display when engaged in full braking.

On the other hand, in normal driving, the driver determines a target point for stopping or deceleration, determines the amount of brake force, based on experience and the distance to that point and on the current vehicle speed, and brakes accordingly. However, braking based solely on experiential judgment of the driver may not result in the expected deceleration, due to differences in road surface conditions and road layouts and so forth. In such cases, the driver needs to further change force on the brake pedal, which may result in awkward handling the vehicle, causing discomfort to other passengers, and placing an unnecessary load on the vehicle.

### SUMMARY OF THE INVENTION

Accordingly, it is an object of the present invention to provide a vehicle braking control assistance device and a vehicle braking control assistance method, for enabling the driver to appropriately determine excessive or insufficient current braking force, as compared to an ideal braking force, and to make an appropriate change in force on the brake pedal.

To achieve the foregoing objective, in a first aspect, the present invention provides a vehicle braking control assistance device which includes: vehicle speed detecting means for detecting the current vehicle speed; brake force detecting means for detecting the currently applied braking force; deceleration target point determining means for determining a deceleration target point; target vehicle speed determining means for determining a target vehicle speed at the deceleration target point; ideal brake force determining means for determining an ideal braking force in approaching the deceleration target point in order to reach the target vehicle speed at the deceleration target point, based on the current vehicle speed, the deceleration target point and the target vehicle speed; notification information generating means for generating notification information indicating the relationship between the ideal braking force and the current braking; and notification means for bringing the notification information to the attention of the driver.

According to this first aspect of the invention, the driver is notified of the relationship between the ideal braking force and the current braking force and, accordingly, the driver can appropriately determine whether the current braking force is excessive or insufficient as compared to the ideal braking force and adjust the current braking force to approximate the ideal braking force.

Thus, the notification information preferably includes the difference between the ideal braking force and current braking force and, more preferably, includes not only the absolute value of the difference, but also the direction of the difference.

Accordingly, the driver of the vehicle can know the difference between the ideal brake pedal force and current brake pedal force, so that the driver can adjust the current brake pedal force to more closely approximate the ideal brake force.

Also, the ideal brake force determining means preferably has a plurality of ideal brake force patterns of braking forces correlated with the distance to the deceleration target point, with one ideal brake force pattern being selected based on the current vehicle speed, the target vehicle speed, and the distance from the current position of the vehicle to the deceleration target point, and the ideal brake force is determined utilizing the selected ideal brake force pattern.

Accordingly, the ideal brake force to be applied can be determined in accordance with conditions including the current vehicle speed, the target vehicle speed, and the distance from the current position of the vehicle to the deceleration target point, without any complicated computation.

The vehicle braking control assistance device of the invention preferably further comprises ideal vehicle speed determining means for determining ideal vehicle speeds up to the deceleration target point, so as to arrive at the target vehicle speed at the deceleration target point, based on the current vehicle speed, the deceleration target point and the target vehicle speed; wherein the notification information generating means generates notification information including the relationship between the ideal vehicle speed and the current vehicle speed, and the relationship between the ideal braking force and the current braking force.

Accordingly, the driver of the vehicle can know both the relationship between the ideal vehicle speed and the current vehicle speed, and the relationship between the ideal braking force and the current braking force and, accordingly, can appropriately determine whether the current braking force is excessive or insufficient and adjust current braking force to approximate the ideal braking force.

The vehicle control assistance device preferably further includes ideal vehicle speed determining means for determining an ideal vehicle speed(s) up to the deceleration target point so as to realize the target vehicle speed at the deceleration target point, based on the current vehicle speed, the deceleration target point and the target vehicle speed; wherein the notification information generating means generates notification information illustrating the relationship between the ideal vehicle speed and the current vehicle speed, and the relationship between the ideal vehicle speed and a future predicted vehicle speed, based on the current braking force.

Accordingly, the driver of the vehicle is informed of both the relationship between the ideal vehicle speed and the current vehicle speed, and the relationship between the ideal vehicle speed and a future predicted vehicle speed based on the current braking force and is thereby forewarned of how the vehicle speed will change based on the current braking force. Accordingly, the driver can adjust the current vehicle speed to approximate the ideal vehicle speed.

Also, the notification information preferably further includes information indicating the position of a predicted deceleration point at which the target vehicle speed will be reached by deceleration with the current braking force. Accordingly, the driver of the vehicle can know the location for the target vehicle speed relative to the deceleration target point, with deceleration in accordance with the current braking force, so that the brake application can be adjusted such that the target vehicle speed is reached at the deceleration target point.

The vehicle braking control assistance device preferably further includes ideal braking force correction means for correcting the ideal braking force, based on the difference between the ideal braking force and the actual current braking force and the difference between the ideal vehicle speed and the current, actual vehicle speed.

Accordingly, even in the event that the degree of change of vehicle speed relative to the braking force changes due to changes in road conditions, road grades, weather, etc., the deviation can be corrected to better notify the driver of the ideal braking force.

According to a second aspect of the present invention, the vehicle control assistance device includes: vehicle speed detecting means for detecting the current vehicle speed; brake operation force detecting means for detecting the currently applied braking force; deceleration target point determining means for determining a deceleration target point; target vehicle speed determining means for determining a target vehicle speed at the deceleration target point; ideal vehicle speed determining means for determining an ideal vehicle speed(s) to the deceleration target point in order to reach the target vehicle speed at the deceleration target point, based on the current vehicle speed, the deceleration target point and the target vehicle speed; notification information generating means for generating notification information indicating the relationship between the ideal vehicle speed and current vehicle speed; and notification means for bringing the notification information to the attention of the driver.

According to this second aspect of the invention, the driver is notified of the relationship between the current vehicle speed and the ideal vehicle speed and, accordingly, the driver can appropriately determine whether the current vehicle speed is excessive or insufficient as compared to the ideal vehicle speed. More suitable vehicle control can be achieved by controlling the braking such that the current vehicle speed closely approximates the ideal vehicle speed.

The ideal vehicle speed determining means preferably has a plurality of ideal vehicle speed patterns wherein ideal vehicle speeds are correlated with the distance to the deceleration target point, with one ideal vehicle speed pattern being selected based on the current vehicle speed, the target vehicle speed, and the distance from the current position of the vehicle to the deceleration target point, and the ideal vehicle speed is determined according to the selected ideal vehicle speed pattern.

Accordingly, the ideal vehicle speed can be determined in accordance with conditions such as the current vehicle speed, the target vehicle speed, and the distance from the current position of the vehicle to the deceleration target point, without need for any complicated computation.

The notification means may make known the notification information by one or more of images, audio, and vibration.

The vehicle braking control assistance device of the invention preferably further includes preceding vehicle detecting means for detecting a preceding vehicle in the direction of travel of the vehicle; wherein the preceding vehicle detecting means determines a point at which a predetermined vehicular gap can be maintained relative to a preceding vehicle, and sets that determined point as the deceleration target point; and wherein the target vehicle speed determining means sets the vehicle speed of the preceding vehicle as the target vehicle speed.

Accordingly, in the event that there is a preceding vehicle ahead, braking control can provide for following the preceding vehicle while maintaining an appropriate vehicular gap therebetween.

The vehicle braking control assistance device preferably further includes stopping target feature detecting means for detecting a stopping target feature; wherein the deceleration target point determining means sets the vehicle stopping point corresponding to the stopping target as the deceleration target point when no preceding vehicle has been detected by the preceding vehicle detecting means; and wherein the target vehicle speed determining means sets the target vehicle speed at zero.

Accordingly, in the event that no preceding vehicle is detected ahead in the direction of travel of the vehicle, braking control can be provide for stopping the vehicle at an appropriate position relative to a stopping target feature such as a stop line, a traffic signal, a stop sign, a crosswalk, or the like.

In a third aspect, the present invention, is a vehicle braking control assistance device which includes: notification information generating means for generating, at the time of deceleration of the vehicle, notification information indicating the relationship between the current braking force and a range for ideal braking force; i.e. ideal for reaching a deceleration target point; and notification means for bringing the notification information to the attention of the driver.

In this third aspect of the invention, the driver of the vehicle, when decelerating, can be made aware of the relationship the current braking force in comparison with the range for the ideal braking force, and can thereby determine whether the current braking force is excessive or insufficient as compared to the range for ideal braking force. Accordingly, the driver can adjust pressure on the brake pedal to bring the current braking force within the range for the ideal braking force.

The vehicle braking control assistance device preferably further includes automatic control mean for automatic control of one or both of braking force and vehicle speed; wherein automatic control by the automatic control means is executed when the notification information satisfies predetermined conditions during communication thereof to the driver.

Accordingly, appropriate vehicle braking control can be provided by automatic control means in the event that the driver does not perform appropriate braking responsive to receipt of notification information from the notifying means. On the other hand, if the driver performs appropriate vehicle control, automatic control by the automatic control means may be omitted, so that vehicle control can be manually provided to match the preference of the driver.

In a fourth aspect, the present invention provides a vehicle control assistance method including: detecting the current vehicle speed of the vehicle and determining a deceleration target point for deceleration control of the vehicle; determining a target vehicle speed at the deceleration target point; determining an ideal braking force to be applied in order to reach the target vehicle speed at the deceleration target point, based on the current vehicle speed, the deceleration target point and the target vehicle speed; detecting the current braking force generating notification information indicating the relationship between the ideal braking force and the detected current braking force; and communicating the generated notification information to the driver.

In a fifth aspect the present invention provides a vehicle control assistance method which comprises: determining a deceleration target point for deceleration control of the vehicle; determining a target vehicle speed at the deceleration target point; determining ideal vehicle speeds for reaching the deceleration target point in order to establish the target vehicle speed at the deceleration target point, based on the current vehicle speed, the deceleration target point and the target vehicle speed; generating notification information indicating the relationship between the ideal vehicle speed and current vehicle speed; and communicating the notification information to the driver.

### BRIEF DESCRIPTION OF THE DRAWINGS

FIG. 1 is a block diagram of an embodiment of a vehicle braking control assistance device 1 according to the present invention;

FIG. 2 illustrates determination of a deceleration target point and a target vehicle speed when a preceding vehicle is detected;

FIG. 3 illustrates determination of a deceleration target point and a target vehicle speed when a stopping target feature(s) is detected;

FIG. 4 illustrates the structure of map information stored in the map database;

FIGS. 5(a) and 5(b) are graphs showing examples of an ideal vehicle speed and an ideal brake force curve N and an ideal brake pedal force range R (FIG. 5(b));

FIGS. 6(a)-6(c) are diagrams illustrating examples of ideal vehicle speed patterns stored in the ideal vehicle speed pattern database;

FIGS. 7(a)-7(c) are diagrams illustrating examples of ideal brake pedal force patterns stored in the ideal brake force pattern database;

FIGS. 8(a) and 8(b)illustrate an example of notification information according to the first embodiment of the present invention;

FIG. 9 is a flowchart of the overall vehicle braking control according to the first embodiment of the present invention;

FIG. 10 is a flowchart of the subroutine of step #02 in FIG. 9;

FIG. 11 is a flowchart of the subroutine of step #03 in FIG. 9;

FIG. 12 is a graph showing notification information according to a second embodiment of the present invention;

FIG. 13 illustrates an example of notification information according to a third embodiment of the present invention; and

FIG. 14 is a flowchart of operation of the vehicle control assistance device according to a sixth embodiment of the present invention.

### DESCRIPTION OF THE PREFERRED EMBODIMENTS

### First Embodiment

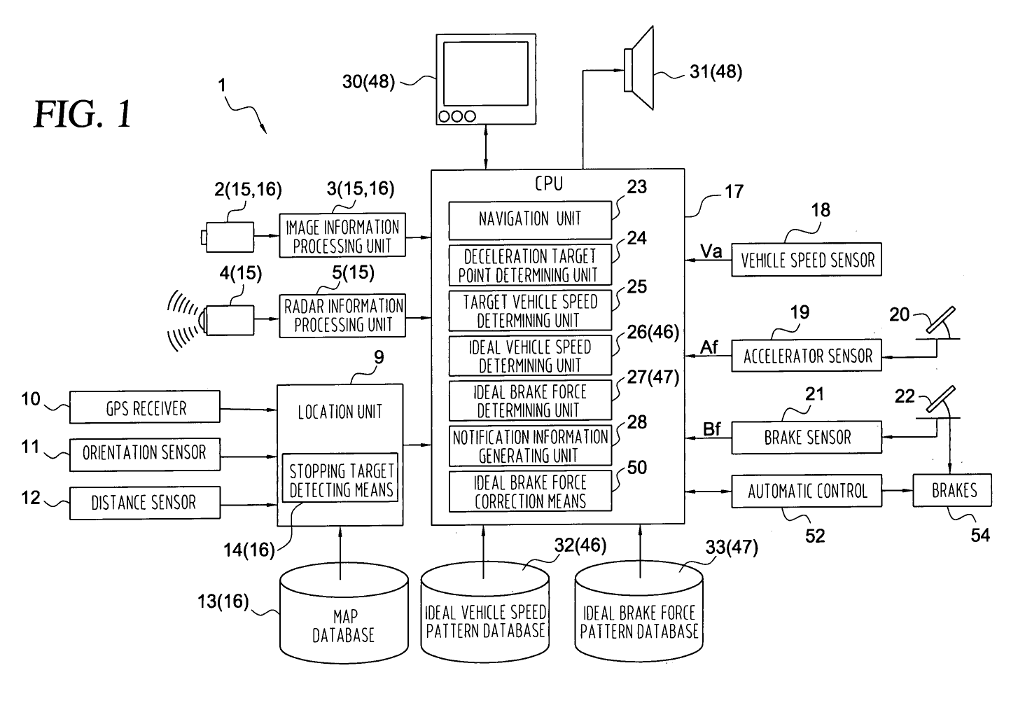

The vehicle control assistance device 1, according to a first embodiment of the present invention generates, when decelerating, information indicating the relationship between an ideal braking force and the current braking force and/or the relationship between ideal vehicle speed and the current vehicle speed, and communicates that information to the driver, thereby assisting in vehicle braking control. FIG. 1 shows the units of the vehicle braking control assistance device 1, which may be hardware or software (programs) or both, with an arithmetic processing unit such as a CPU serving as the central member, which units execute various routines for processing input data.

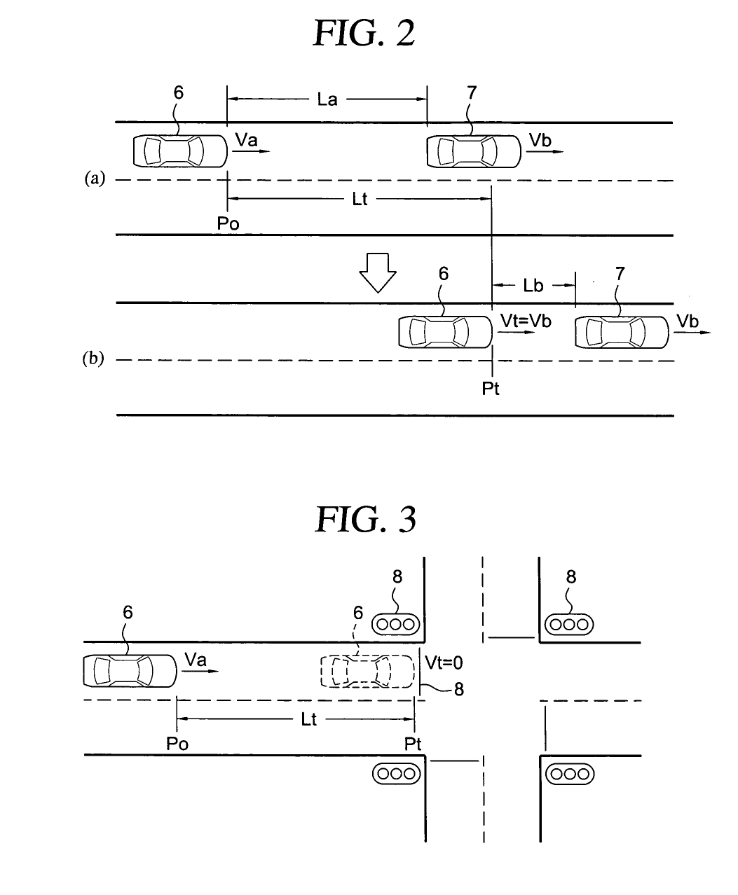

An image-taking device 2 is disposed in a driver's vehicle 6 for capturing images of the vicinity of the driver's vehicle 6, including preceding vehicles 7 ahead of the vehicle 6 in the direction of travel (see FIG. 2), stopping target features 8 (see FIG. 3), and so forth. Image-taking device 2 can be an imaging device such as a CCD sensor or CMOS sensor or the like, and lenses and the like providing an optical system for guiding light to the imaging device. Examples of the stopping target features 8 include, for example, stop lines, traffic signals, stop signs, crosswalks, and so forth, located at intersections or the like. Output from the image-taking device 2 is input to an image information processing unit 3 which processes the output from the image-taking device 2 (image processing), for image recognition of preceding vehicles 7 ahead of the vehicle 6 in the direction of travel and/or stopping target features 8, and for determining distance from the vehicle 6 to the preceding vehicle 7 (current vehicular gap La) or the distance to the stopping target feature 8. The image information processing unit 3 outputs information obtained by the image recognition to a computation processing unit (CPU) 17.

In this first embodiment, the image-taking device 2 and the image information processing unit 3 together serve as the “preceding vehicle detecting means 15” and as the “stopping target detecting means 16” of the present invention.

A radar unit 4 is provided for detecting both the existence of a preceding vehicle 7 in the direction of travel (see FIG. 2) and the distance to the preceding vehicle 7, i.e., the current vehicular gap La. The radar unit 4 may be a laser radar, milliwave radar, infrared beam radar, or the like. Output signals from the radar 4 unit are input to a radar information processing unit 5. The radar information processing unit 5 processes the output signals from the radar 4 and determines whether or not there is a preceding vehicle 7, and the vehicular gap La to the preceding vehicle 7, and outputs the determined information to the CPU 17.

In the present embodiment, the radar unit 4 and the radar information processing unit 5 together serve as the “preceding vehicle detecting means 15” of the present invention.

A location unit 9 receives inputs from a GPS receiver 10, orientation sensor 11, and distance sensor 12. The GPS receiver 10 receives signals from GPS satellites, and obtains various items of information from the received signals, such as the position (latitude and longitude) of the GPS receiver, date, time, and so forth. The orientation sensor 11 is a geomagnetic sensor or gyro sensor, optical rotational sensor, a potentiometer attached to an element which rotates with the steering wheel, angle sensors associated with the wheels, or the like, for detecting the orientation of the vehicle. The distance sensor is a combination of a speed sensor for detecting the rotational speed of the wheels or a yaw/G sensor for detecting acceleration of the vehicle 6, and a circuit for twice integrating the detected acceleration, thereby determining the distance which the vehicle has traveled. The location unit 9 computes the position and orientation of the vehicle by known methods, based on the information obtained from the GPS receiver 10, orientation sensor 11, and distance sensor 12.

The location unit 9 also obtains map information from a map database 13, based on the position and orientation of the vehicle 6 determined as described above. The location unit 9 then performs map matching according to known techniques, based on the obtained map information, locates the position of the vehicle 6 on a road included in the map information, and corrects the determined orientation of the vehicle 6 to match the direction of the road. The position and orientation of the vehicle 6 thus determined by the location unit 9 are output to the CPU 17 as vehicle position information and vehicle orientation information.

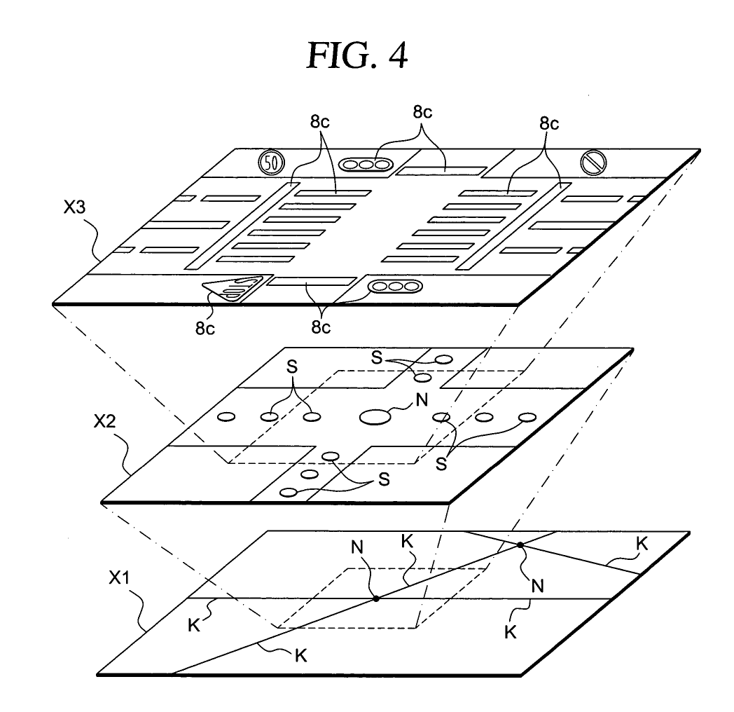

The map database 13 stores map information as illustrated in FIG. 4. As shown in FIG. 4, the stored map information includes a road network layer X1, a road information layer X2, and a background layer X3. The map database 13 is hardware in the form of a recording medium capable of storing information and driving means thereof, such as a hard disk drive, a DVD drive for a DVD-ROM, a CD drive for a CD-ROM, or the like.

The road network layer X1 is a layer of information for connections among roads. Specifically, layer X1 includes a large number of nodes N, with position on the map represented in terms of latitude and longitude, and a large number of links K made up of roads linking two nodes N. Link information for links K includes the road type (freeway, toll road, national highway, local road, etc.), the lengths of the links, and the like.

The road information layer X2 consists of items of information, stored in correlation with the items of information in the road network layer X1, pertaining to details of the road. Specifically, the road network layer X1 includes a large number of shape supplementation points S located between nodes N (on a link K), with their map positions represented in terms of latitude and longitude.

The background layer X3 consists of data correlated with that of the road network layer X1 and the road information layer X2, which data represents background information pertaining to the road and various features of the vicinity therearound, utilized in generation of a map display. Specifically, information stored in the background layer X3 includes, for example, information for locations of features 8c which could serve as stopping target features 8, such as stop lines, traffic signals, stop signs, crosswalks, and the like located, for example, at intersections. The background layer X3 also contains information pertaining to traffic signs, lines and instructions painted on the road, the positions and shapes of various features such as buildings, road shapes, and so forth.

The location unit 9 also has a stopping target feature position extracting unit 14 for extracting positions of stopping target features 8 (position information) from the map database 13. More specifically, the stopping target feature position extracting unit 14 extracts one or more features 8c from the map database 13, based on the vehicle position information and vehicle orientation information determined by the location unit 9, and processes the extracted feature information to determine type (stop line, traffic signal, stop sign, or the like) and positions of the features. A predetermined distance may be set for extracting the features 8c for example, 100 m or the like. The information obtained by the stopping target feature position extracting unit 14 is output to the CPU 17. For example, where the vehicle 6 is located as shown in FIG. 3, the stop line and the two traffic signals ahead in the direction of travel of the vehicle 6 are extracted as the stopping target features 8.

In this first embodiment, the stopping target feature position extracting unit 14 and the map database 13 together serve as the “stopping target feature detecting means 16” of the present invention.

A vehicle speed sensor 18 detects the current vehicle speed Va of the vehicle 6 and is, for example, a rotation detection sensor for detecting the rotational speed of the output shaft of the transmission of the driveshaft. The vehicle speed sensor 18 outputs the current vehicle speed Va to the CPU 17.

In the present embodiment, the vehicle speed sensor 18 is the “vehicle speed detecting means” of the present invention.

An accelerator sensor 19 detects the throttle opening Af by detecting extent of depression of the gas pedal 20. A brake sensor 21 detects brake pedal force Bf on brake pedal 22. In the present embodiment, the brake pedal force Bf output from the brake sensor 21 is equivalent to the “brake force” or “braking force” in the present invention, and the brake sensor 21 serves as the “brake force detecting means”. The accelerator sensor 19 and the brake sensor 21 output the throttle opening Af and the brake pedal force Bf to the CPU 17.

The CPU 17 has a navigation unit 23, deceleration target point determining unit 24, target vehicle speed vehicle speed determining unit 25, ideal vehicle speed determining unit, ideal brake force determining unit, and information notification unit 28. The notification unit 28 includes a display device 30, such as a liquid crystal display and an audio output device 31 such as speakers and an amplifier, for presenting information to (notifying) the driver. The CPU 17 is also connected to an ideal vehicle speed pattern database 32 which stores ideal vehicle speed patterns, and an ideal brake force pattern database 33 storing ideal brake force patterns.

The navigation unit 23 executes various navigation routines, such as searching for a route to an input destination, display of the position of the vehicle, map display, route guidance, and so forth. The navigation unit 23 receives, as inputs, the vehicle position information and vehicle orientation information from the location unit 9, and map information from this map database 13 via the location unit 9 based on this vehicle position information and vehicle orientation information. The navigation unit 23 then uses this inputted information for processing to generate a map display, to search for a guidance route from the current vehicle position to a destination, to generate route guidance for following the guidance route, etc. Here, the navigation unit 23, by video (display) and audio outputs, communicates the results of computation through the display device 30 and audio output device 31. Input operations for setting destinations, searching, and so forth, are made through a touch panel integral with the display device 30, remote controller, or the like.

The deceleration target point determining unit 24 determines a deceleration target point Pt which is a target point for deceleration of the vehicle 6. In the present embodiment, the deceleration target point determining unit 24 determines the deceleration target point Pt based on a preceding vehicle 7 as a reference or a stopping target feature 8 as a reference.

The target vehicle speed vehicle speed determining unit 25 executes a process to determine the target vehicle speed at the deceleration target point Pt. In the present embodiment, the target vehicle speed vehicle speed determining unit 25 takes the vehicle speed Vb of the preceding vehicle 7 as a reference, in the event of detection of a preceding vehicle 7 in the direction of travel of the vehicle 6 (Vt=Vb), and sets the target vehicle speed to zero in the event that a preceding vehicle 7 has not been detected but a stopping target feature 8 has been detected (Vt=0).

For example, in the event that the state of the vehicle 6 is as shown in FIG. 2, the presence of preceding vehicle 7 is detected by the image information processing unit 3 and the radar information processing unit 5. In this case, the deceleration target point determining unit 24 determines a point at which the predetermined target vehicular gap Lb, i.e. distance to the preceding vehicle 7, will become constant, as the deceleration target point Pt. The target vehicle speed determining unit 25 sets the vehicle speed of the preceding vehicle 7 as the target vehicle speed Vt (Vt=Vb). The target vehicular gap Lb is then set according to the target vehicle speed Vt. The target vehicular gap Lb is predetermined and stored as a table or map in accordance with the target vehicle speed Vt, or may be determined by computation using a relational formula which is a function of target vehicle speed Vt determined beforehand. In the event that the preceding vehicle 7 is moving, the deceleration target point Pt is determined assuming that the preceding vehicle 7 will continue to travel at the same speed while the speed of the vehicle 6 drops from the current vehicle speed Va to the target vehicle speed Vt (=Vb), e.g. drops as indicated in FIGS. 2(a) and 2(b). Stated differently, the deceleration distance Lt, i.e. the distance from the current position of the vehicle 6 to the deceleration target point Pt, is obtained by adding, to the difference between the current vehicular gap La and the target vehicular gap Lb, the distance which the preceding vehicle 7 will travel during the time in which the vehicular gap between the vehicle 6 and the preceding vehicle 7 is increased from the current vehicular gap La to the target vehicular gap Lb and, further, the vehicle speed of the vehicle 6 decelerates to the target vehicle speed Vt. Specifically, the deceleration distance Lt to the deceleration target point Pt is calculated from the following Expression (1).
Lt=(La−Lb)(Va+Vb)/(Va−Vb) (1)

The deceleration target point Pt is a point determined by the distance the vehicle 6 will travel during deceleration to the target speed, i.e. the deceleration distance Lt.

Note that the vehicle speed Vb of the preceding vehicle 7 can be calculated based on outputs from the image information processing unit 3 and the radar information processing unit 5. Thus, the relative speed between the vehicle 6 and the preceding vehicle 7 can be calculated from the change of the vehicular gap La with passage of time, obtained from outputs of the image information processing unit 3 and the radar information processing unit 5. The vehicle speed Vb of the preceding vehicle 7 can then be calculated from this relative speed and the current vehicle speed of the vehicle 6.

In the event that the preceding vehicle 7 is stopped (Vb=0), the target vehicle speed Vt is also zero (Vt=0) and, therefore, the deceleration distance Lt to the deceleration target point Pt is the difference between the current vehicular gap La and the target vehicular gap Lb. The target vehicular gap at this time is normally the smallest value for the target vehicular gap Lb determined according to the target vehicle speed Vt.

On the other hand, in the event that the state of the vehicle 6 is as shown in FIG. 3, no preceding vehicle 7 is detected and a stop line and traffic signals are detected as stopping target features 8 based on the image recognition processing and the extraction of stopping target features 8 by the stopping target feature position extracting unit 14 of the location unit 9. In this case, the deceleration target point determining unit 24 determines the vehicle stopping position corresponding to the stopping target features 8 as the deceleration target point Pt. In this case vehicle speed determining unit 25 sets the target vehicle speed Vt at zero (V=0). The vehicle stopping position corresponding to the stopping target features 8 is the position where the vehicle 6 should stop and information relating to the features 8c which are potential stopping target features 8 are stored in the map database 13 beforehand. In the example shown in FIG. 3, the stop line and the two traffic signals existing in the direction of travel of the vehicle 6 are extracted as stopping target features 8, and the vehicle stopping position corresponding thereto is the position of the vehicle 6 at which the front end of the vehicle 6 is slightly short of the stopping line. Also, in this case, the deceleration distance Lt to the deceleration target point Pt is the distance from the current position of the vehicle 6 to the vehicle stopping position corresponding to the stopping target features 8. Note that in the event that multiple vehicle stopping positions corresponding to stopping target features 8 are extracted by the stopping target feature position extracting unit 14, the vehicle stopping position closest to the current position of the vehicle 6 is set as the deceleration target point Pt.

Accordingly, in the present embodiment, the deceleration target point determining unit 24 serves as the “deceleration point determining means” and the vehicle speed determining unit 25 serves as the “target vehicle speed determining means”.

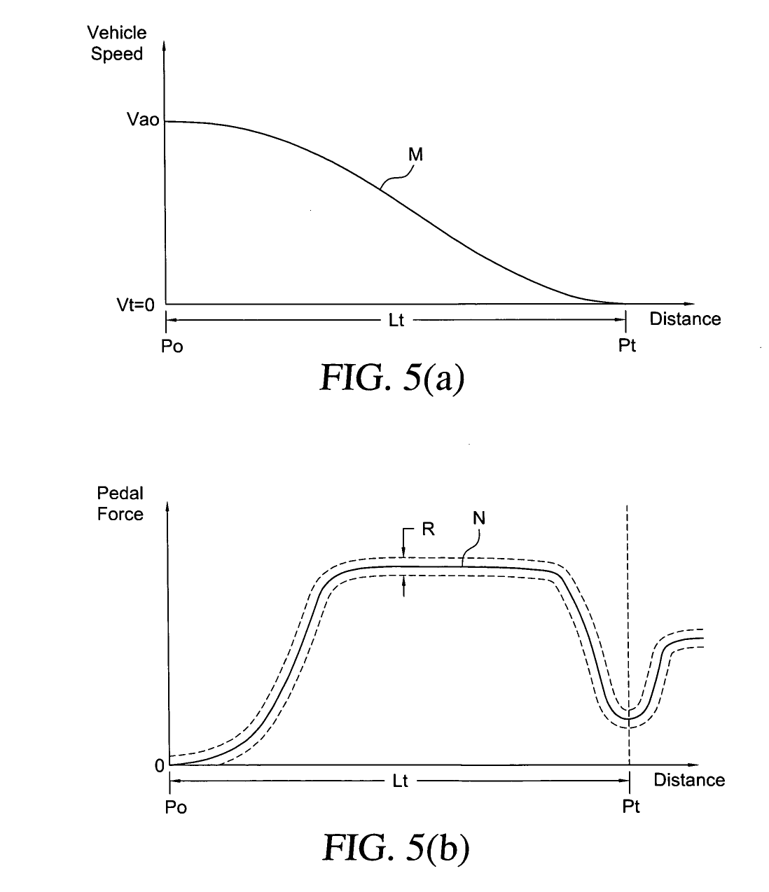

Ideal vehicle speed determining unit 26 determines the ideal vehicle speed to the deceleration target point Pt such that the target vehicle speed Vt will be achieved at the deceleration target point Pt, based on the current vehicle speed Va detected by the vehicle speed sensor 18, the deceleration target point Pt determined by the deceleration target point determining unit 24, and the target vehicle speed Vt determined by the vehicle target speed determining unit 25. In the present embodiment, the ideal vehicle speed determining unit 26 determines that deceleration of the vehicle 6 has begun at the point when the accelerator sensor 19 has detected closing of the throttle, and determines an ideal vehicle speed curve M stipulating the ideal vehicle speeds up to the deceleration target point Pt, with the vehicle position at that time as a starting point Po (see FIGS. 2 and 3). Note that FIG. 5(2) illustrates an example of an ideal vehicle speed curve M determined in this way, illustrating the ideal vehicle speed curve M for decelerating throughout the deceleration distance Lt, from the starting point Po to the deceleration target point Pt, wherein the current vehicle speed at the starting point Po is Vao and the target vehicle speed Vt is zero (Vt=0). The vehicle speed stipulated by this ideal vehicle speed curve M is the ideal vehicle speed at each point up to the deceleration target point Pt.

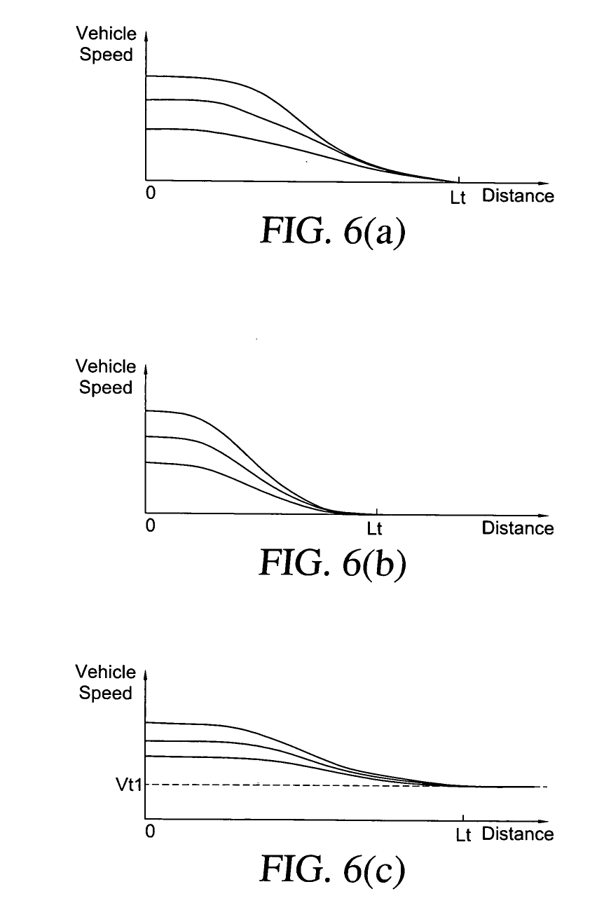

In the present embodiment, the ideal vehicle speed determining unit 26 determines the ideal vehicle speed by selecting one ideal vehicle speed pattern from among multiple ideal vehicle speed patterns stored in the ideal vehicle speed pattern database 32. FIG. 6 shows diagrams illustrating examples of ideal vehicle speed patterns stored in the ideal vehicle speed pattern database 32. As shown in these drawings, the ideal vehicle speed pattern database 32 stores multiple ideal vehicle speed patterns correlating vehicle speed with the deceleration distance Lt from the starting point Po to the deceleration target point Pt, the conditions of the current vehicle speed Vao at the starting point Po, the target vehicle speed Vt, and the deceleration distance Lt, all differing as between the different multiple ideal vehicle speed patterns. Note that FIG. 6(a) shows examples of ideal vehicle speed patterns for three different current vehicle speeds Vao at the starting point Po where the target vehicle speed is zero (V=0) and the deceleration distance Lt is relatively long, FIG. 6(b) shows examples wherein the deceleration distance Lt is relatively shorter than in FIG. 6(a), and FIG. 6(c) shows examples wherein the target vehicle speed Vt is not zero as with 6(a) but is Vt1 (Vt=Vt1). These examples of FIGS. 6(a) through 6(c) are only representative of the large number of ideal vehicle speed patterns stored in the ideal vehicle speed pattern database 32 and covering practically all driving situations which the vehicle 6 might encounter.

The ideal vehicle speed determining unit 26 selects an ideal vehicle speed pattern matching the current vehicle speed Vao at the current starting point Po, the target vehicle speed Vt, and the deceleration distance Lt, from among the multiple ideal vehicle speed patterns. In the event that there is no ideal vehicle speed pattern which matches the current vehicle speed Vao at the current starting point Po, the target vehicle speed Vt, and the deceleration distance Lt, the ideal vehicle speed pattern which is the closest is selected.

With the present embodiment, the ideal vehicle speed determining unit 26 and the ideal vehicle speed pattern database 32 serves as the “ideal vehicle speed determining means 46” of the present invention.

An ideal brake force determining unit 27 determines the ideal braking force for reaching the deceleration target point target point Pt at the target vehicle speed Vt based on the current vehicle speed Va detected by the vehicle speed sensor 18, the deceleration target point Pt determined by the deceleration target point determining unit 24, and the target vehicle speed Vt determined by the vehicle speed determining unit 25. In the present embodiment, the ideal brake force determining unit 27 determines that deceleration of the vehicle 6 has begun at the point that the accelerator sensor 19 has detected closing of the throttle, and determines an ideal brake pedal force curve N for the ideal pedal forces up to the deceleration target point Pt, with the vehicle position at that time as a starting point Po (see FIGS. 2 and 3). Here, 2/30 an ideal brake pedal force range R corresponding to the ideal brake pedal force curve N is also determined. FIG. 5(b) is an example of an ideal brake pedal force curve N and the ideal brake pedal force range R based thereon, for the deceleration distance Lt from the starting point Po, where the current vehicle speed Va at the starting point Po is Vao and the target vehicle speed Vt is zero (Vt=0).

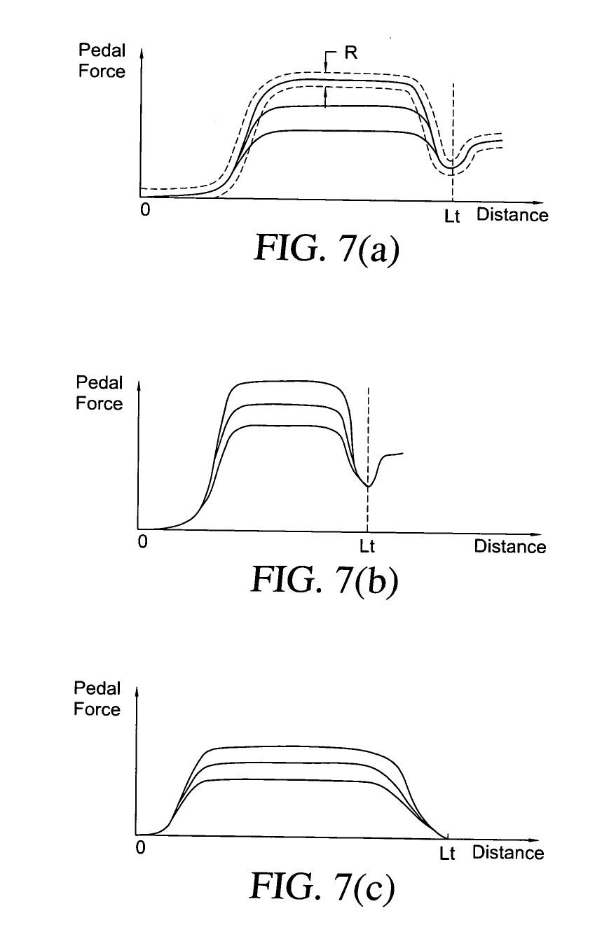

In the present embodiment, the ideal brake force determining unit 27 determines an ideal brake pedal force curve N by selecting one ideal brake pedal force pattern from among the multiple ideal brake pedal force patterns stored in the ideal brake force pattern database 33. FIGS. 7(a)-7(c) illustrate examples of ideal brake pedal force patterns stored in the ideal brake force pattern database 33. As shown in FIGS. 7(a)-7(c), the ideal brake force pattern database 33 stores multiple ideal brake pedal force patterns for different current vehicle speeds Va at the starting point Po, target vehicle speeds Vt, and deceleration distances Lt, each pattern giving ideal brake pedal forces to be applied along the deceleration distance Lt, from the starting point Po to the deceleration target point Pt. The conditions for the ideal brake pedal force patterns match the conditions of the multiple ideal vehicle speed patterns described above. Further, the ideal brake pedal force patterns are stored in correlation with the multiple ideal vehicle speed patterns stored in the ideal vehicle speed pattern database 32, in an one-on-one relationship.

The multiple ideal brake pedal force patterns in 7(a) through 7(c) correspond to the ideal vehicle speed patterns illustrated in 6(a) through 6(c). In the ideal brake pedal force patterns for the same deceleration distance Lt, the higher the current vehicle speed Vao at the starting point Po the greater the brake pedal force. Also, with the conditions for the ideal brake pedal force patterns shown in 7(a) and 7(b) the target vehicle speed Vt is zero (Vt=0), and accordingly, the ideal brake pedal force pattern is such that the brake pedal force is temporarily small near the end point of the deceleration distance Lt (deceleration target point Pt) and then becomes larger to bring to the vehicle 6 to a complete stop. On the other hand, with the conditions of the ideal brake pedal force pattern shown in FIG. 7(c), the target vehicle speed Vt is not zero, and the vehicle 6 continues to travel following deceleration, so that the brake pedal force is zero at the end point of the deceleration distance Lt (deceleration target point Pt). FIGS. 7(a) through 7(c) are only examples of the ideal brake pedal force patterns stored in the ideal brake force pattern database 33, and in actual practice, the ideal brake pedal force patterns cover practically all driving situations which the vehicle 6 could experience.

Also, the ideal brake force pattern database 33 stores ideal brake pedal force ranges in correlation with each of the multiple ideal brake pedal force patterns. While FIG. 7(a) shows the ideal brake pedal force range for only one ideal brake pedal force pattern, actually an ideal brake pedal force range is correlated with each ideal brake pedal force pattern in the same way.

The ideal brake force determining unit 27 selects, from the multiple ideal brake pedal force patterns, an ideal brake pedal force pattern correlated with the ideal vehicle speed pattern selected by the ideal vehicle speed determining unit 26, and that selected pattern becomes the selected ideal brake pedal force pattern information as the ideal brake pedal force curve N. Accordingly, the ideal brake force determining unit 27 selects one ideal brake pedal force pattern based on the current vehicle speed Vao at the starting point Po, the target vehicle speed Vt, and the deceleration distance Lt. Also, the ideal brake force determining unit 27 sets the ideal brake pedal force range stored in correlation with the selected ideal brake pedal force pattern as the ideal brake pedal force range R.

In the present embodiment, the ideal brake pedal force pattern and the ideal brake pedal force range serve as the “ideal brake force pattern” of the present invention, and the ideal brake determining unit 27 and the ideal brake force pattern database 33 serve as the “ideal brake force determining means 47” of the present invention.

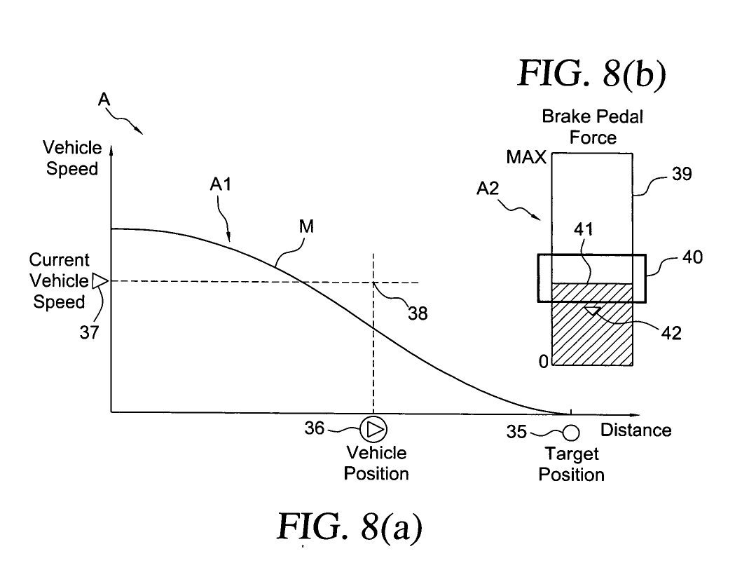

The notification information generating unit 28 generates notification information A for the relationship between the ideal vehicle speed, taken from the ideal vehicle speed curve M, and the current vehicle speed Va detected by the vehicle speed sensor 18, and the relationship between the ideal brake pedal force, taken from the ideal brake pedal force curve N, and the ideal brake pedal force range R and the current brake pedal force Bf. FIG. 8 is a diagram illustrating an example of the notification information A according to the present embodiment. As shown in FIG. 8, the notification information A here is image information for display of the difference between the ideal vehicle speed and the current vehicle speed Va, and the difference between the ideal brake pedal force range R and the current brake pedal force Bf, thereby notifying the driver of the vehicle. The notification information A shown in FIG. 8 illustrates an example wherein the ideal vehicle speed curve M, ideal brake pedal force curve N, and ideal brake pedal force range R have been determined as shown in FIG. 5, i.e., wherein the target vehicle speed Vt at the deceleration point Pt is zero (Vt=0)

The notification information A shown in FIG. 8 includes vehicle speed display information A1 for use in display of the ideal vehicle speed curve M along with the current vehicle speed Va for comparison, and brake pedal force display information A2 for use in display of the ideal brake pedal force range R and the current brake pedal force Bf for comparison. More specifically, the ideal vehicle speed curve M is displayed as a graph wherein the horizontal axis represents distance and the vertical axis represents vehicle speed. A target position marker 35 representing the deceleration target point Pt and a vehicle position marker representing the position of the vehicle are also located on the horizontal axis. Further, a current vehicle speed indicator 37, representing the current vehicle speed Va, is located on the vertical axis. The intersection 38 between the vehicle position and the current vehicle speed Va enables the current position and the current vehicle speed of the vehicle 6 to be displayed in a manner enabling comparison with the ideal, i.e. ideal vehicle speed curve M. The display of brake pedal force information A2, as shown in FIG. 8(b), is a rectangular region 39 representing the brake pedal force, from the maximum value (MAX) of brake pedal force to the minimum value (0). Also included in the brake pedal force display 39 of FIG. 8(b) is an ideal pedal force range display 40 representing .the ideal brake pedal force range R determined by the ideal brake force determining unit 27 and a current pedal force line 41 representing the current brake pedal force Bf, for comparison therebetween. Further, a direction-of-change indicator 42 is disposed above or below the ideal pedal force range display 40, for showing the direction of change of the brake pedal force Bf.

In the present embodiment, the notification information generating unit 28 serves as the “notification information generating means” of the present invention.

The notification information A generated by the notification information generating unit 28 is displayed on the display screen 30 for notification to the driver of the vehicle 6. Accordingly, in the present embodiment, the display device 30 is the “notification means 48” of the present invention.

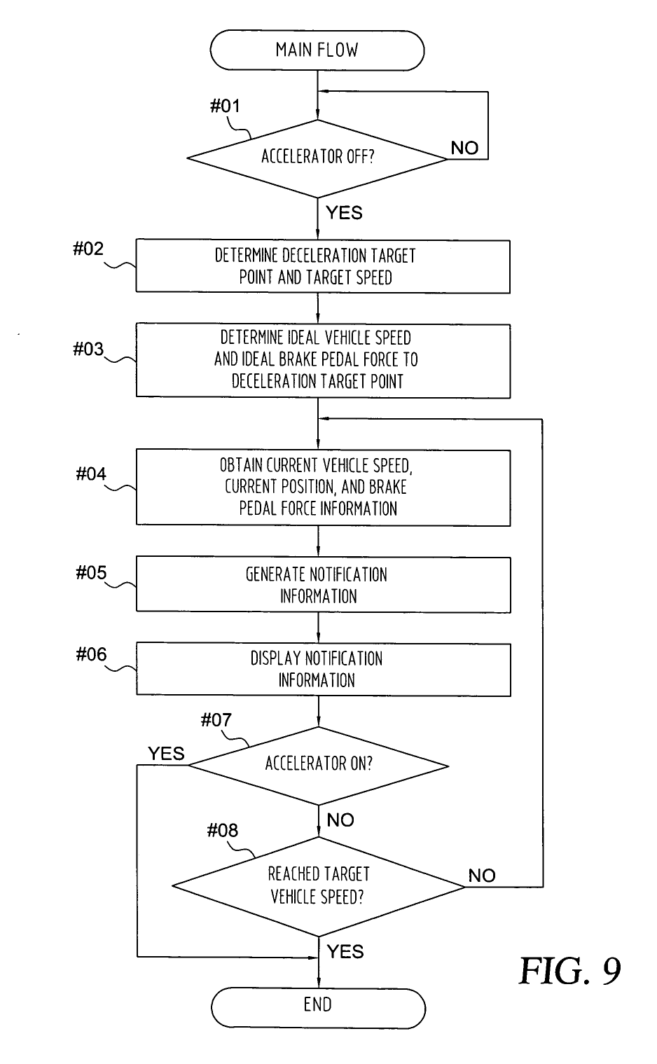

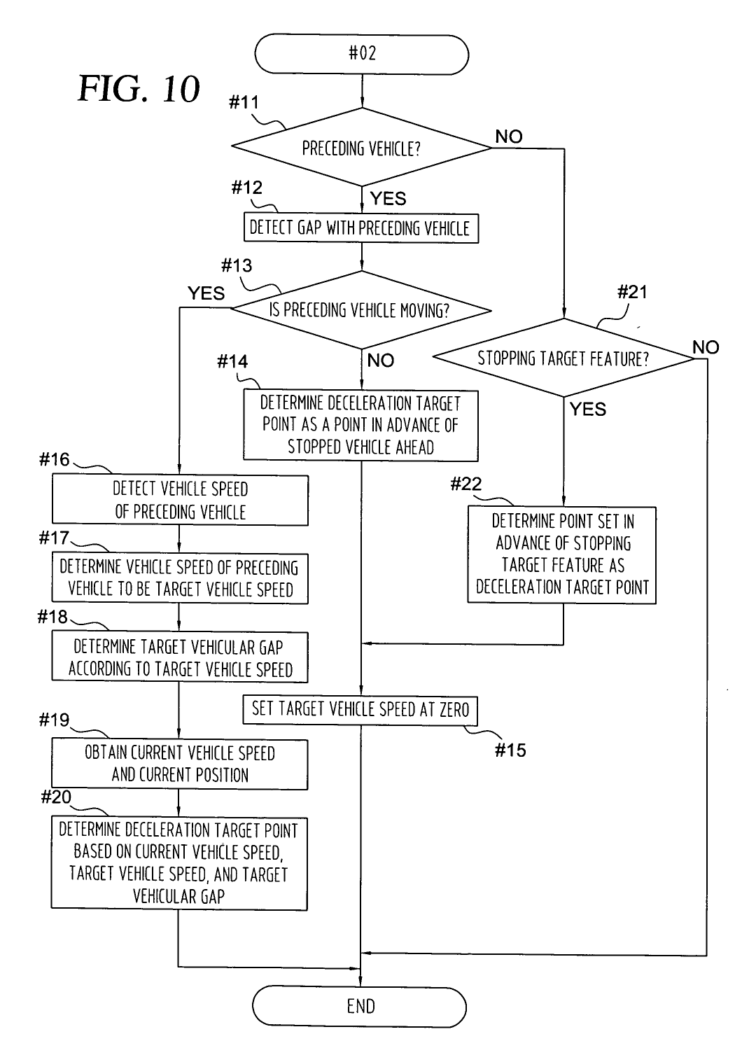

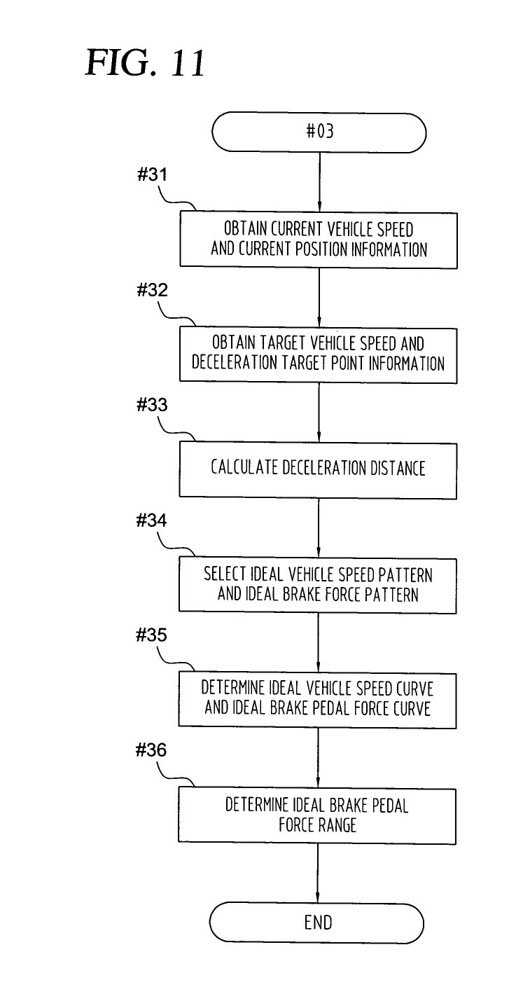

The vehicle control method implemented by the vehicle control assistance device 1 of the present embodiment will be described with reference to the flowcharts of FIGS. 9-11. FIG. 9 illustrates the overall operational scheme of the vehicle control assistance device 1 according to the present invention. FIG. 10 is a flowchart illustrating the details of a subroutine for determining the deceleration target point Pt and target vehicle speed Vt in step #02 in FIG. 9. FIG. 11 is a flowchart illustrating the details of a subroutine for determining the ideal vehicle speeds and the ideal brake pedal forces to be targeted en route to the deceleration target point Pt in step #03 in FIG. 10.

As shown in FIG. 9, the vehicle brake control assistance device 1 according to the present embodiment determines whether or not the throttle has been closed, based on the throttle opening Af detected by the accelerator sensor 19 (step #01). When there is no operation for closing the throttle performed (“No” in step #01), a determination is made that the vehicle 6 is not going to decelerate, so the routine does not proceed to the subsequent steps. In the event that an operation for closing the throttle is detected (“Yes” in step #01), a determination is made that the vehicle 6 is going to decelerate, and, responsive to that determination, the deceleration target point determining unit 24 and vehicle speed determining unit 25 determine, respectively, the deceleration target point Pt and the target vehicle speed Vt (step #02). The details of this step #02 are described later with reference to the flowchart of FIG. 10. Next, the vehicle brake control assistance device 1 executes a routine for determining the ideal vehicle speeds and the ideal brake force(s) along the distance to the deceleration target point Pt, in order to attain the target vehicle speed at the deceleration target point Pt, based on the detected current vehicle speed Va, the deceleration target point Pt determined in step #02 and the target vehicle speed Vt, utilizing the ideal vehicle speed determining unit 26 and ideal brake force determining unit 27 (step #03). The details of this step #03 will be described later with reference to the flowchart of FIG. 11.

Next, the vehicle brake control assistance device 1 obtains information regarding the current vehicle speed Va from the vehicle speed sensor 18, information regarding the current position from the location unit 9, and information regarding the brake pedal force Bf from the brake sensor 21 (step #04). Notification information A is generated by the notification information generated unit 28 (step #05), and the generated notification information A is displayed on the display screen 30 (step #06). Subsequently, the vehicle brake control assistance device 1 determines whether or not throttle operation has been performed, based on the throttle opening Af detected by the accelerator sensor 19 (step #07). In the event that no throttle operation has been performed (“No” in step #07), a determination is made that deceleration control of the vehicle 6 is continuing (step #08). In the event that the current vehicle speed Va has not yet attained the target vehicle speed Vt (“No” in step #08), the processing returns to step #04, new current vehicle speed Va information, current position information, and brake pedal force Bf information are obtained, the contents of the notification information A are updated, and notified by the display device (steps #04 through #06). The processing of the steps #04 through #08 is repeatedly performed at predetermined time intervals. Note that the predetermined time intervals at which the processing of the steps #04 through #08 is performed may be, for example, around 10 to 50 ms. In the event that an operation for operating the throttle has been performed (“Yes” in step #07), determination is made that the vehicle 6 will accelerate, so the operation of the vehicle brake control assistance device 1 for deceleration control is ended. Also, in the event that the current vehicle speed Va has attained the target vehicle speed Vt (“Yes” in step #08), a determination is made that the deceleration control has ended, so the operation of the vehicle brake control assistance device 1 ends in this event also.

Next, the subroutine for determining the deceleration target point Pt and the target vehicle speed Vt in step #02 will be described. This subroutine is executed by at the deceleration target point determining unit 24 and vehicle speed determining unit 25 of the CPU 17. As shown in FIG. 10, in this subroutine, a determination is first made regarding whether or not a preceding vehicle 7 has been detected as a result of the operation of the image information processing unit 3 and the radar information processing unit 5 (step #11). In the event that a preceding vehicle 7 has been detected (“Yes” in step #11), the current vehicular gap La to the preceding vehicle 7 is determined based on the outputs of the image information processing unit 3 and the radar information processing unit 5 (step #12). Next, a determination is made regarding whether or not the preceding vehicle 7 is moving (step #13). This determination can be made based on the current vehicle speed Va detected by the vehicle speed sensor 18 and the amount of change in the current vehicular gap a detected in step #12. Thus, in the event that the reduction of the current vehicular gap La is approximately the same as the travel distance of the vehicle 6 at the current vehicle speed Va, the preceding vehicle 7 is determined to be stationary. Otherwise, the preceding vehicle 7 is determined to be moving.

In the event that the preceding vehicle 7 is stopped (“No” in step #13), a point in advance of the stopped vehicle 7, a predetermined stopped vehicle gap, is set as the deceleration target point Pt by the deceleration target point determining unit 24 (step #14). The stopped vehicle gap is a value set for the target vehicular gap Lb which is determined for a target vehicle speed Vt zero (Vb=0). The target vehicle speed Vt is set as zero, so as to match the vehicle speed Vb (Vb=0) of the preceding vehicle 7, by the vehicle speed determining unit 25 (step #15). Thus, the routine is ended.

On the other hand, in the event that the preceding vehicle 7 is determined to be moving in step #13 (“Yes” in step #13), the vehicle speed Vb of the preceding vehicle 7 is detected (step #16). The vehicle speed Vb of the preceding vehicle 7 can be calculated based on the change in of the vehicular gap La over passage of time based on outputs of the image information processing unit 3 and the radar information processing unit 5. Next, the speed Vb of the preceding vehicle 7 is set as the target vehicle speed Vt for the vehicle 6 by the vehicle speed determining unit 25 (step #17). The target vehicular gap Lb is then determined according to the target vehicle speed Vt (step #18). Subsequently, information regarding the current vehicle speed Va from the vehicle speed sensor 18, and information regarding the current position based on the vehicle position information from the location unit 9, are obtained (step #19). The “current position” here is the vehicle position at the point of detection of the throttle closing (step #01), which serves as the starting position Po of deceleration control (see FIGS. 2 and 3). The deceleration target point Pt is then determined by the deceleration target point determining unit 24, based on the current vehicle speed Va, the target vehicle speed Vt, the current position (starting point Po), and the target vehicular gap Lb (step #20). Specifically, the deceleration target point determining unit 24 calculates the deceleration distance Lt from the current position to the deceleration target point Pt, utilizing the equation (1) as described above, and determines a point in advance of the current position by the deceleration distance Lt, as the deceleration target point Pt.

Also, in the event that no preceding vehicle 7 is detected (“No” in step #11), a determination is then made regarding whether or not a stopping target feature 8 is detected, based on the results of image recognition processing by the image information processing unit 3, and by the stopping target feature position extracting unit 14 of the location unit 9 (step #21). In the event that no stopping target feature 8 is detected (“No” in step #21), the routine is ended. In the event that a stopping target feature 8 is detected (“Yes” in step #21), the deceleration target point determining unit 24 sets the detected stopping target feature 8 as the deceleration target point Pt (step #22). Specifically, the deceleration target point determining unit 24 sets a vehicle stopping position, predetermined for the stopping target feature 8, as the deceleration target point Pt. Subsequently, the routine proceeds to step #15 where the vehicle speed determining unit 25 sets the target vehicle speed Vt to zero (step #15). Thus, the processing ends.

Next, details of the subroutine for determining the ideal vehicle speed and the ideal brake pedal force for travel to the deceleration target point Pt in step #03 will be described with reference to the flowchart of FIG. 11. This subroutine is performed by the ideal vehicle speed determining unit 26 and the ideal brake force determining unit 27 of the CPU unit 17. As shown in FIG. 11, in this subroutine, first, information regarding the current vehicle speed Va is obtained from the vehicle speed sensor 18, and information regarding the current position based on the vehicle position information from the location unit 9, is obtained (step #31). The “current position” here also is the vehicle position at the point when throttle closing is detected (step #01), which serves as the starting position Po for deceleration control (see FIGS. 2 and 3). Next, the deceleration target point Pt and the target vehicle speed Vt determined in the above step #02 are obtained (step #32). The deceleration distance Lt from the starting point Po to the deceleration target point Pt is then calculated (step #33). Next, an ideal vehicle speed pattern is selected from the ideal vehicle speed pattern database 32, based on the current vehicle speed Va, target vehicle speed Vt, and deceleration distance Lt, and an ideal brake pedal force pattern correlated with the selected ideal vehicle speed pattern is selected from the ideal brake force pattern database 33 (step #34). The ideal vehicle speed pattern selected in step #34 is set as the ideal vehicle speed curve M, and the ideal brake pedal force pattern selected in step #34 is set as the ideal brake pedal force curve N (step #35). Also, ideal brake pedal force range information stored correlated with the ideal brake pedal force pattern selected in step #34 is set as the ideal brake pedal force range R (step #36). The ideal vehicle speed curve M thus determined is formed by linking the ideal vehicle speeds for each point, from the current position (starting point Po) to the deceleration target point Pt. Likewise, the ideal brake pedal force curve N is formed by linking the ranges of ideal brake pedal force for each point, from the current position (starting point Po) to the deceleration target point Pt.

### Second Embodiment

The vehicle brake control assistance device 1 according to the second embodiment differs from the previously described first embodiment with regard to the contents of the notification information generated by the notification information generating unit 28. Other components and features are the same as those of the first embodiment.

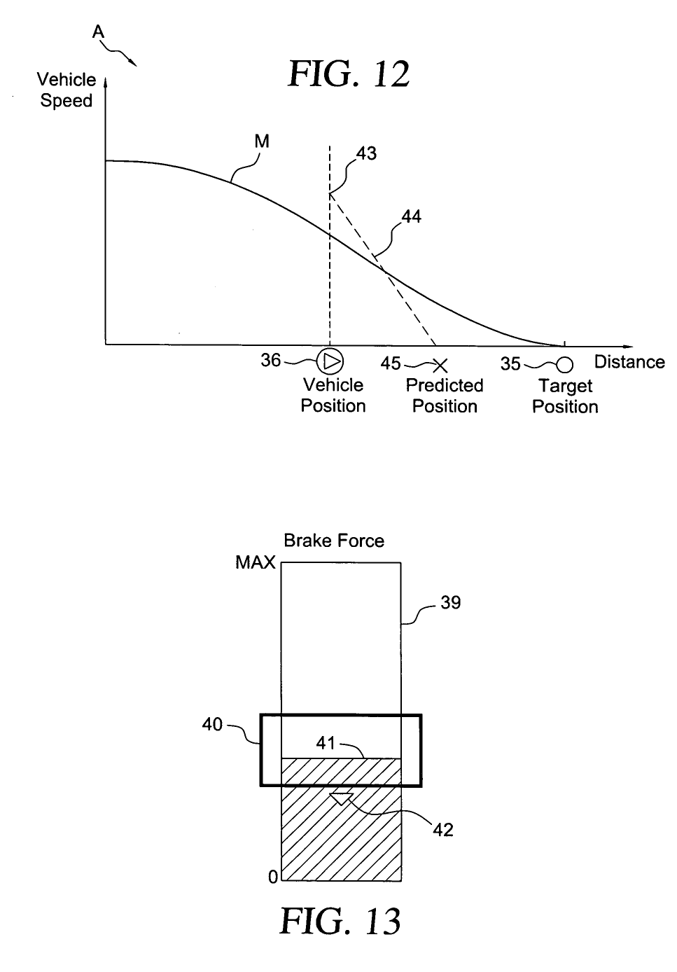

FIG. 12 illustrates one example of the notification information A according to the second embodiment. As shown in FIG. 12, the notification information A here is image information for display on the display device 30, and gives the relationship between the ideal vehicle speed and the current vehicle speed Va, and the relationship between the ideal vehicle speed and a predicted vehicle speed based on the current Bf. This notification information A further includes information indicating a future predicted deceleration point which determines the target vehicle speed Vt based on the assumption that deceleration will continue at the current brake pedal force Bf. The notification information A shown in FIG. 8 illustrates an example wherein the ideal vehicle speed curve M, ideal break pedal force curve N, and ideal brake pedal force range R have been determined as shown in FIG. 5, i.e., wherein the target vehicle speed Vt at the deceleration point Pt is zero (Vt=0). Note that in this embodiment, as well as in the first embodiment, the brake pedal force Bf detected by the brake sensor 21 is equivalent to the “brake force” or “braking force” in the present invention.

The notification information A shown in FIG. 12 also includes information for displaying the ideal vehicle speed curve M and the current vehicle speed Va in a manner enabling a comparison. The notification information A also includes information for display of the current vehicle speed and the predicted vehicle speed based on the current brake pedal force Bf in a manner enabling a comparison and for display of the position of the deceleration target point Pt and the predicted deceleration point at the current brake pedal force Bf, again in a manner enabling a comparison. Specifically, the notification information A is used to display the ideal vehicle speed curve M as a graph wherein the horizontal axis represents distance and the vertical axis represents the vehicle speed. Also, a target position mark 35 representing the deceleration target point Pt and the target position of the vehicle is displayed on the horizontal axis. A current vehicle speed/position 43 which is a point on the graph representing the current position and the current vehicle speed Va is displayed above the vehicle position marker 36. Accordingly, the current position and current vehicle speed Va of the vehicle 6 are displayed in a manner providing comparison with the ideal vehicle speed curve M. Further, the notification information A includes information for generating a display of a predicted vehicle speed line 44 with the starting point being at the current vehicle speed/position 43. Accordingly, the vehicle speed and the future predicted vehicle speed based on the current brake pedal force Bf are displayed in a manner enabling comparison. A predicted position 45 which represents the position of the predicted deceleration point at the target vehicle speed Vt with deceleration continuing at the current brake pedal force Bf, is displayed at a point where the predicted vehicle speed line 44 intersects the horizontal axis. Accordingly, the position of the deceleration target point Pt and the predicted deceleration point are displayed together for comparison.

Next, a third embodiment of the vehicle brake control assistance device 1 will be described. The vehicle brake control assistance device 1 according to the third embodiment differs from the first embodiment in that only the ideal brake force(s) for reaching the deceleration target point Pt at the target vehicle speed Vt is determined, without determining the ideal vehicle speed to the deceleration target point Pt, and information regarding the relationship between the ideal brake force and the current brake force Bf is generated as notification information A. Accordingly, the vehicle brake control assistance device 1 of the third embodiment also differs from that of the first embodiment in that there is no need for an ideal vehicle speed determining unit 26. Other components and features may be the same as those of the first embodiment.

In the third embodiment, the ideal brake force determining unit 27 selects an ideal brake pedal force pattern matching the current vehicle speed at the current starting point Po, the target vehicle speed Vt, and the deceleration distance Lt, from among the multiple ideal brake pedal force patterns stored in the ideal brake pattern database 33, and sets the selected ideal brake pedal force pattern as the ideal brake pedal force curve N. In the event that there is no ideal brake pedal force pattern matching the current vehicle speed at the current start point Po, the target vehicle speed Vt, and the deceleration distance Lt, the closest ideal brake pedal force pattern is selected. Also, the ideal brake force determining unit 27 sets the ideal brake pedal force range, stored correlated with the selected ideal brake pedal force pattern, as the ideal brake pedal force range R.

The notification information generating unit 28 generates notification information A indicating the relationship between the ideal brake pedal force stipulated by the ideal brake pedal force curve N and the ideal brake pedal force range R, and the current brake pedal force Bf detected by the brake sensor 21. FIG. 13 illustrates an example of the notification information A generated in the third embodiment. As shown in FIG. 13, the notification information A is screen information for display on the display device 30, showing the difference between the ideal brake pedal force range R and the current brake pedal force Bf, by which such information is made available to the driver of the vehicle 6.

In FIG. 13 information showing the ideal brake pedal force range R and the actual (detected) brake force Bf are displayed together for comparison similar to the brake pedal force display A2 of the first embodiment shown in FIG. 8. That is to say, the notification information display includes the rectangular region display 39 of the brake pedal force from the maximum value (MAX) of the brake pedal force to the minimum value (0). Also included in the pedal force display 39 are the ideal pedal force range 40, representing the ideal brake pedal force range R determined by the ideal brake force determining unit 27, and the current pedal force 41 representing the current brake pedal force Bf, displayed together for comparison. Further, a direction-of-change display 42, disposed above or below the ideal pedal force range display 40, indicates the direction of change of the brake pedal force Bf.

### Fourth Embodiment

Next, a fourth embodiment of a vehicle control assistance device 1 will be described. The vehicle control assistance device 1 of the fourth embodiment differs from the above embodiment in that only the ideal vehicle speed(s) to the deceleration target point Pt at the target vehicle speed is determined, without determining the ideal brake force up to the deceleration target point Pt, and information indicating the relationship between the ideal vehicle speed and the current vehicle speed Va is generated as the notification information A. Accordingly, the vehicle control assistance device 1 according to the fourth embodiment also differs from the above first embodiment in that there is no need to have an ideal brake force determining unit 27. Other components and features may be the same as those of the first embodiment.

In the fourth embodiment, the notification information generating unit 28 generates notification information A indicating the relationship between the ideal vehicle speed stipulated by the ideal vehicle speed curve M and the current vehicle speed Va detected by the speed sensor. Specifically, while not shown in the drawings, information is generated having a configuration similar to that of the vehicle speed information A1 of the first embodiment described above, shown in FIG. 8.

### Fifth Embodiment

Next, a vehicle brake control assistance device 1 according to a fifth embodiment of the present invention will be described. The vehicle brake control assistance device 1 according to the fifth embodiment differs from the first embodiment in that it further includes an ideal brake force correcting unit 50 for correcting the ideal brake pedal force based on the difference between the ideal brake pedal force and the current brake pedal force, and the difference between the ideal vehicle speed and the current vehicle speed, utilizing the CPU 17. Other components and features may be the same as those of the first embodiment. That is to say, the degree of change of vehicle speed relative to the braking force often changes depending on road conditions, road grade, weather, etc. The ideal brake force correcting unit 50 is for correcting for such factors affecting change in vehicle speed relative to brake force.

In the fifth embodiment, the ideal brake force correcting unit 50 performs processing for correcting the ideal brake pedal force curve N and the ideal brake pedal force range R in the event that the current vehicle speed Va does not change in the same way as does the ideal vehicle speed stipulated by the ideal vehicle speed curve M with the current brake pedal force Bf, detected by the brake sensor 21 within the ideal brake pedal force range R. For this purpose, the ideal brake force correcting unit 50 uses a correction coefficient determined according to the difference between (1) the amount of change in the current vehicle speed Va relative to the distance of travel of the vehicle 6, and the amount of change in the ideal vehicle speed stipulated by the ideal vehicle speed curve M. The values at each of the points on the ideal brake pedal force curve N are multiplied by this correction coefficient, thereby correcting by increasing or decreasing the ideal brake pedal force values at each point on the ideal brake pedal force curve N. At this time, the ideal brake pedal force range R is corrected according to the amount of the correction to the ideal brake pedal force curve N, with no change to the width thereof.

With the fifth embodiment, the ideal brake force correcting unit 50 serves as the “ideal brake force correcting means” of the present invention.

### Sixth Embodiment

Next, a vehicle brake control assistance device 1 according to a sixth embodiment of the present invention will be described. The vehicle brake control assistance device 1 according to the sixth embodiment differs from the first embodiment in that it further includes an automatic control unit 52 for automatic control of one or both of the braking force and the vehicle speed based on the notification information A. This automatic control unit 52 is connected to the brake device 54, throttle device, etc., of the vehicle 6 via a vehicle control device or the like, and is designed so as to be capable of control of these devices. Other components and features may be the same as those of the first embodiment. In the event that the state of the vehicle, including the notification information A, satisfies a predetermined condition during display of the notification information A by the display device 30 (an example of the notification means 48), the automatic control unit 52 performs automatic control of one of both of the braking force and the speed of the vehicle 6. Note that in this sixth embodiment, the automatic control unit serves as the “automatic control means” in the present invention.

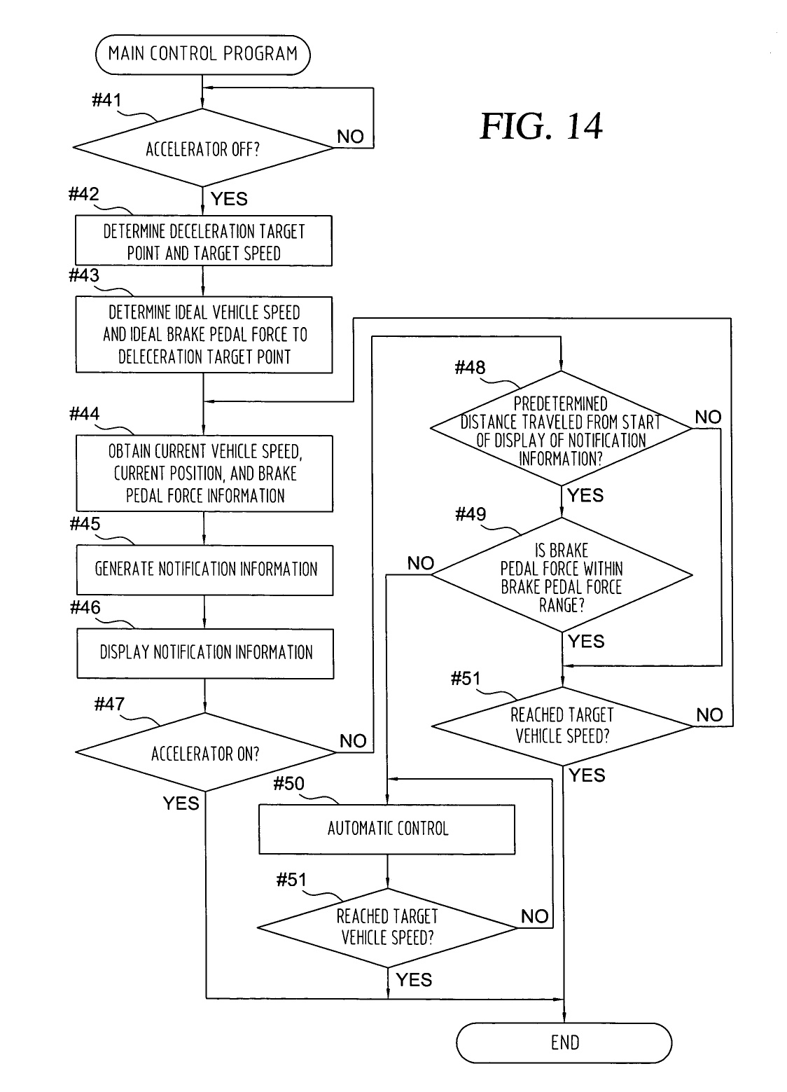

FIG. 14 is a flowchart illustrating an example of operation of the vehicle brake control assistance device 1 the sixth embodiment. In this example, the automatic control unit executes an automatic control routine for one or both of the braking force and the speed of the vehicle 6 in the event that the brake pedal force Bf is not within the ideal brake pedal force range R at the point where the vehicle has traveled a predetermined distance beginning with start of display of the notification information A on the display device 30.

Steps #41 through #47 in the flowchart shown in FIG. 14 are the same as the steps #01 through #07 in FIG. 9 of the first embodiment, so description thereof will not be repeated here. In the present example, following display of the notification information A generated in step #45 (step #46), in the event that no throttle opening operation is detected (“No” in step #47), a determination is made regarding whether or not the vehicle 6 has traveled a predetermined distance since start of display of the initial notification information A with the display device 30 (step #48). The predetermined distance can be set as a distance equal to or less than the deceleration distance Lt to the deceleration target point Pt, and may be, for example, ½ of the deceleration distance Lt. In the event that the vehicle 6 has traveled the predetermined distance since start of notification (“Yes” in step #48), a determination is made regarding whether or not the current brake pedal force Bf obtained in step #44 is within the ideal brake pedal force range R determined in step #43 (step #49).

In the event that the brake pedal force Bf is not within the ideal brake pedal force range R (“No” in step #49), the automatic control unit 52 executes automatic control of one or both of the braking force and vehicle speed (step #50). The automatic control is continued until the current vehicle speed Va of the vehicle 6 attains the target vehicle speed Vt (“Yes” in step #51). The automatic control unit 52 controls braking force to approximate the ideal brake force (ideal brake pedal force curve N) determined in step #43, or controls vehicle speed to approximate the ideal vehicle speed (ideal vehicle speed curve M) determined in step #43. On the other hand, in the event that the vehicle 6 has traveled the predetermined distance since start of notification (“No” in step #48), or in the event that the brake pedal force Bf is within the ideal brake pedal force range R (“Yes” in step #49), the automatic control routine proceeds to step #51. This step #51 is the same as step #08 in FIG. 9 in the first embodiment, so description thereof will not be repeated here.

In other preferred embodiments the automatic control unit 52 executes an automatic control routine responsive to a determination that the brake pedal force Bf is not within the ideal brake pedal force range R a predetermined time after start of display of the notification information A, or a executes an automatic control routine responsive to a determination that the brake pedal force Bf has remained outside of the ideal brake pedal force range R for a predetermined time or longer.

With the vehicle brake control assistance device 1 of the sixth embodiment, in the event that the driver fails to perform appropriate braking after receipt of the notification information, one or both of the braking force and vehicle speed of the vehicle 6 is appropriately and automatically controlled by the automatic control unit 52.

In yet another preferred embodiment, following start of automatic control (step #50), automatic control is ended after traveling a predetermined distance or after a predetermined time, and subsequently, the notification information A is merely displayed for notification to the driver. In yet another preferred embodiment, following determination or detection of closing the throttle (“Yes” in step #41), operation of the automatic control unit 52 is immediately started, and the automatic control is ended after traveling a predetermined distance or after a predetermined time and, thereafter, the notification information A is only displayed. In such an embodiment, the driver reassumes control of braking in the final stage of deceleration control, so that braking will match the preferences of the driver.

Also, while display of the notification information A can be suspended while performing automatic control with the automatic control unit 52, the display of the notification information A may be continued even during automatic control with display of the current brake pedal force Bf as controlled by the automatic control unit 52. Also during automatic control, preferably the driver is notified by the display device 30 and/or the audio output device 31, that automatic control is in effect. In this case, the words “Currently under automatic control” can be displayed on the display device 30, the words “Currently under automatic control” can be emitted from the audio output device 31, or the like.

Modifications

(1) While the foregoing embodiments have been described as having a display device 30 which serves as the notification means 48 and as generating notification information A in the form of image information for display on the display unit 30, the present invention is not restricted to the use of a display device as the notification means. Alternatively, the notification means of the present invention may be the audio output device 31 for audio output of the notification information A, a vibration generating device provided in the driver's seat or other such device.

For example, where the audio output device 31 is used as the notification means 48, volume, tone, audio patterns, etc., may be changed in accordance with the difference between the ideal vehicle speed and the current vehicle speed, difference between the ideal brake pedal force and the current brake pedal force Bf, and so forth. The notification information will include not only the difference between current and ideal vehicle speeds and/or the difference between current and ideal brake pedal forces, but also the direction of the difference(s) (whether above or below the ideal value), in addition to the absolute value of the difference.

Similarly, where a vibration generating device is adopted as the notification means 48, the amplitude of vibration, vibration frequency, vibration patterns, etc., may be changed in accordance with the difference between the ideal vehicle speed and the current vehicle speed, or the difference between the ideal brake pedal force and the current brake pedal force Bf.

Of course other preferred embodiments include notification means 48 which combine two or more of video, audio, and vibration.

In other embodiments the notification information may be communicated, not to the driver of the vehicle, but rather to the vehicle control device of the vehicle 6. In this case, the notification information generating means generates information indicating one or both of the relationship between the ideal brake force and the current brake force and the relationship between the ideal vehicle speed and the current vehicle speed in a format capable of output to the vehicle control device. Also in this case, the notification means may be the combination of a CPU serving as the notification information generating means and a communication device or the like connecting the CPU to the vehicle control device. Accordingly, the vehicle control device can control braking by output of braking signals to the brake device, so that the current brake force more closely approximates the ideal brake force, or such that the current vehicle speed more closely approximates the ideal vehicle speed.

The foregoing embodiments have been described as having an ideal vehicle speed determining unit 26 which determines the ideal vehicle speed curve M by selecting one of multiple ideal vehicle speed patterns stored in the ideal vehicle speed pattern database 32, and an ideal brake force determining unit 27 which determines the ideal brake pedal force curve N by selecting one of multiple ideal brake pedal force patterns stored in the ideal brake force pattern database 33. However, the scope of the present invention is not so restricted. For example, the ideal vehicle speed determining unit 26 may determine the ideal vehicle speed(s) the up to the deceleration target point Pt such that the target vehicle speed Vt is reached at the deceleration target point Pt, by computation based the current vehicle speed Va detected by the vehicle speed sensor 18, the deceleration target point Pt determined by the deceleration target point determining unit 24, and the target vehicle speed Vt determined by the vehicle speed determining unit 25, in accordance with a predetermined mathematical expression or formula. In the same way, ideal brake force determining unit 26 may calculate the ideal brake force to be applied in travel to the deceleration target point Pt such that the target vehicle speed Vt is reached at that deceleration target point Pt, based on the current vehicle speed Va detected by the vehicle speed sensor 18, the deceleration target point Pt determined by the deceleration target point determining unit 24, and the target vehicle speed Vt determined by the vehicle speed determining unit 25, using a predetermined mathematical expression or the like. Of course, the ideal vehicle speed determining unit 26 may determine the ideal vehicle speed curve M by selecting one of multiple ideal vehicle speed patterns stored in the ideal vehicle speed pattern database 32, while the ideal brake force determining unit 27 computes and determines the ideal brake force based on data taken from the ideal vehicle speed curve M.

Further, while the foregoing embodiments have been described as determining the deceleration target point based on detection of preceding vehicles 7 (see FIG. 2) or stopping target features 8 (see FIG. 3) by the image-taking device 2 and radar 4. However, the scope of application of the present invention is not so restricted, and other preferred embodiments may determine a deceleration target point based on detection of, for example, pedestrians, bicycles, vehicles stopped roadside, objects in the road, road shapes or the like.

While the fifth embodiment was described as including a brake force correcting unit for correcting the ideal brake pedal force, based on the difference between ideal brake pedal force and the current brake pedal force, and the difference between the ideal vehicle speed and the current vehicle speed, correction of the ideal brake pedal force may be effected by a different technique. For example, road conditions, such as road grade and weather, detected by the image-taking device 2 or other device, may be directly applied in correcting the ideal brake force. In this case, a correction coefficient predetermined for the road condition or the like can be used, with the value of a point on the ideal brake pedal force curve N being multiplied by this correction coefficient, thereby correcting by increasing or decreasing that value. Alternatively, multiple ideal brake pedal force patterns differing according to road conditions are stored within the ideal brake force pattern database 33 beforehand, and an appropriate ideal brake force pattern is selected in accordance with the detected road conditions.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A vehicle brake control assistance device comprising:
vehicle speed detecting means for detecting a current vehicle speed of a vehicle;
brake force detecting means for detecting a current brake force on the vehicle;
deceleration target point determining means for determining a deceleration target point;
target vehicle speed determining means for determining a target vehicle speed to be maintained at the deceleration target point;
ideal brake force determining means for determining an ideal brake force to be applied in approaching the deceleration target point in order to realize the target vehicle speed at the deceleration target point, based on the current vehicle speed, the deceleration target point and the target vehicle speed;
notification information generating means for generating notification information indicating a relationship between the ideal brake force and the current brake force; and
notification means for communicating the notification information to the driver of the vehicle.

2. The vehicle brake control assistance device according to claim 1, wherein the notification information includes a difference between the ideal brake force and the current brake force.

3. The vehicle brake control assistance device according to claim 1, wherein the ideal brake force determining means has a plurality of ideal brake force patterns stipulating the brake force in correlation with distance to the deceleration target point, and wherein one ideal brake force pattern is selected based on the current vehicle speed, the target vehicle speed, and the distance from the current position of the vehicle to the deceleration target point, and the ideal brake force is determined according to the selected ideal brake pattern.

4. The vehicle brake control assistance device according to claim 1, further comprising ideal vehicle speed determining means for determining ideal vehicle speed for approaching the deceleration target point so as to realize the target vehicle speed at the deceleration target point, based on the current vehicle speed, the deceleration target point and the target vehicle speed;
wherein the notification information generating means generates notification information illustrating the relationship between the ideal vehicle speed and the current vehicle speed, and the relationship between the ideal brake force and the current brake force.

5. The vehicle brake control assistance device according to claim 1, further comprising ideal vehicle speed determining means for determining ideal vehicle speed for approaching the deceleration target point so as to realize the target vehicle speed at the deceleration target point, based on the current vehicle speed, the deceleration target point and the target vehicle speed;
wherein the notification information generating means generates notification information illustrating the relationship between the ideal vehicle speed and the current vehicle speed, and the relationship between the ideal vehicle speed and a predicted vehicle speed based on the current brake force.

6. The vehicle brake control assistance device according to claim 4, wherein the notification information further includes information indicating position of a deceleration point at which the target vehicle speed will be realized, predicted assuming continuation of deceleration with the current brake force.

7. The vehicle control assistance device according to claim 5, wherein the notification information further includes information indicating position of the deceleration point at which the target vehicle speed will be realized, predicted assuming continuation of deceleration with the current brake force.

8. The vehicle brake control assistance device according to claim 4, further comprising ideal brake force correction means for correcting the ideal brake force based on the difference between the ideal brake force and the current brake force, and the difference between the ideal vehicle speed and the current vehicle speed.

9. The vehicle brake control assistance device according to claim 5, further comprising ideal brake force correction means for correcting the ideal brake force based on the difference between the ideal brake force and the current brake force, and the difference between the ideal vehicle speed and the current vehicle speed.

10. A vehicle brake control assistance device comprising:
vehicle speed detecting means for detecting a current vehicle speed of a vehicle;
brake force detecting means for detecting a current brake force on the vehicle;
deceleration target point determining means for determining a deceleration target point;
target vehicle speed determining means for determining a target vehicle speed at the deceleration target point;
ideal vehicle speed determining means for determining ideal vehicle speed for approaching the deceleration target point in order to realize the target vehicle speed at the deceleration target point, based on the current vehicle speed, the deceleration target point and the target vehicle speed;
notification information generating means for generating notification information indicating a relationship between the ideal vehicle speed and the current vehicle speed; and
notification means for communicating the notification information to the driver of the vehicle.

11. The vehicle brake control assistance device according to claim 10, wherein the ideal vehicle speed determining means has a plurality of ideal vehicle speed patterns stipulating the vehicle speed correlated with distance to the deceleration target point, wherein one of the ideal vehicle speed patterns is selected based on the current vehicle speed, the target vehicle speed, and the distance from the current position of the vehicle to the deceleration target point, and wherein the ideal vehicle speed is determined according to the selected ideal vehicle speed pattern.

12. The vehicle brake control assistance device according to claim 1, further comprising preceding vehicle detecting means for detecting presence of a preceding vehicle;
wherein the deceleration target point determining means determines a point at which a predetermined vehicular gap can be maintained relative to the preceding vehicle as the deceleration target point;
and wherein the target vehicle speed determining means determines the vehicle speed of the preceding vehicle and sets the determined speed of the preceding vehicle as the target vehicle speed.

13. The vehicle brake control assistance device according to claim 10, further comprising preceding vehicle detecting means for detecting presence of a preceding vehicle;
wherein the deceleration target point determining means determines a point at which a predetermined vehicular gap can be maintained relative to the preceding vehicle as the deceleration target point;
and wherein the target vehicle speed determining means determines the speed of the preceding vehicle and sets the determined speed of the preceding vehicle as the target vehicle speed.

14. The vehicle brake control assistance device according to claim 12, further comprising stopping target feature detecting means for detecting a stopping target feature;
wherein the deceleration target point determining means determines a vehicle stopping point corresponding to the stopping target feature and sets the determined vehicle stopping point as the deceleration target point in the event that no preceding vehicle has been detected by the preceding vehicle detecting means; and
wherein the target vehicle speed determining means sets the target vehicle speed to be zero.

15. The vehicle target control assistance device according to claim 13, further comprising stopping target feature detecting means for detecting a stopping target feature;
wherein the deceleration target point determining means determines a vehicle stopping point corresponding to the stopping target feature and sets the determined vehicle stopping point as the deceleration target point in the event that no preceding vehicle has been detected by the preceding vehicle detecting means; and
wherein the target vehicle speed determining means sets the target vehicle speed to be zero.

16. A vehicle brake control assistance device comprising:
notification information generating means for generating, at the time of deceleration of a vehicle, notification information indicating a relationship between the current brake force and an ideal range for brake force in reaching a deceleration target point; and
notification means for communicating the notification information to the driver of the vehicle.

17. The vehicle brake control assistance device according to claim 1, further comprising automatic control means for automatic control of one or both of brake force and vehicle speed;
wherein automatic control is executed by the automatic control means when status of the vehicle including the notification information satisfies at least one predetermined condition during communication of the notification information to the driver.

18. The vehicle brake control assistance device according to claim 10, further comprising automatic control means for automatic control of one or both of brake force and vehicle speed;
wherein automatic control is executed by the automatic control means when status of the vehicle including the notification information satisfies at least one predetermined condition during communication of the notification information to the driver.

19. The vehicle brake control assistance device according to claim 16, further comprising automatic control means for automatic control of one or both of brake force and vehicle speed;
wherein automatic control is executed by the automatic control means when status of the vehicle including the notification information satisfies at least one predetermined condition during communication of the notification information to the driver.

20. A vehicle brake control assistance method comprising:
determining a deceleration target point;
determining a target vehicle speed at the deceleration target point;
detecting a current vehicle speed of the vehicle and determining an ideal brake force to be applied in approaching the deceleration target point in order to realize the target vehicle speed at the deceleration target point, based on the current vehicle speed, the deceleration target point and the target vehicle speed;
detecting current brake force of the vehicle and generating notification information indicating a relationship between the ideal brake force and the current brake force; and
communicating the notification information to the driver of the vehicle.

21. A vehicle brake control assistance method comprising:
determining a deceleration target point which is a target point for deceleration control of a vehicle;
determining a target vehicle speed at the deceleration target point;
detecting current speed of the vehicle and determining an ideal vehicle speed to the deceleration target point in order to realize the target vehicle speed at the deceleration target point, based on the current vehicle speed, the deceleration target point and the target vehicle speed;
generating notification information indicating a relationship between the ideal vehicle speed and the current vehicle speed; and
communicating the notification information to the driver of the vehicle.
